(19) United States
(12) Patent Application Publication
(10) Pub. No.: US 2012/0117020 A1
(43) Pub. Date: May 10, 2012

(54) METHOD AND APPARATUS FOR SMART INDIVIDUAL HEALTH MONITORING

(75) Inventors: Michelle Davis, Raleigh, NC (US); Mark E. Maresh, Rochester Hills, MI (US); Eric A. Stegner, Durham, NC (US); Robert W. Stegner, Raleigh, NC (US)

(73) Assignee: International Business Machines Corporation, Armonk, NY (US)

(21) Appl. No.: 12/942,593

(22) Filed: Nov. 9, 2010

(51) Int. Cl. G06N 5/02

(52) U.S. Cl. 706/54

(57) ABSTRACT

Embodiments of the invention relate to use of sensors for monitoring and gathering data and applications for processing and communicating the gathered data in real-time. The sensor data provides an insight into the daily activities of the user. Analysis of the data supports maintenance of health on a granular level. For each sensor, data is gathered and processed in real-time, including correlating the sensor data with an electronic events schedule. An analysis of the data is then communicated to the user in real-time. Data output is used to pro-actively notify, predict, and/or identify when the user needs to take an action to maintain the current or future sensor data within defined limits.

### BACKGROUND

This invention relates to monitoring and evaluation of physiological stressors that can causes health and well-being issues with electronic scheduled events that may contributes to those stressors. More specifically, the invention relates to management of sensor data and recommendations of an appropriate lifestyle maintenance and/or adjustments in order to reduce the associated stressors through real-time communication.

A sensor is a device that responds to a physical stimulus. There are different forms of sensors available that pertain to different stimuli, including, but not limited to, heat, light, sound, pressure, magnetism, motion, etc. The sensor transmits a resulting impulse for measurement or operating a control. Sensors may be stationary, or in one embodiment, may be worn. In general, the sensors gather data for processing.

### BRIEF SUMMARY

This invention comprises a method, system, and article for real-time monitoring, analysis, and recommendations for health related parameters as it relates to electronic scheduled events.

In one aspect of the invention, a method is provided with a processor in communication with memory. A user profile is created and stored in the memory. The user profile includes historical data that is associated with at least one vital characteristic of the user. This historical data is analyzed, with the analysis ascertaining upper and lower values for one or more vitals over a time interval. Once these limits are ascertained, real-time data associated with at least one of the vitals is acquired in a continuous manner. The acquired data is then analyzed in real-time based upon the profile. This analysis includes comparison of the real-time data with the upper and lower values of the vitals and correlation of an electronic event schedule of the user with the historical data. In real-time, recommendations are provided to the user based upon the analysis, followed by updating the profile with the real-time data.

In another aspect of the invention, a system is provided with a processor in communication with memory. A user profile is stored in the memory, with the user profile including historical data associated with at least one vital of the user. A review manager is provided in the system to analyze the historical data. The analysis by the review manager includes a determination of both lower and upper values for one or more vitals over a predetermined time interval. A data manager is also provided in the system. The data manager functions to acquire real-time data associated with one or more vitals of the user, with the acquisition taking place in a continuous manner. A director is provided in the system in communication with both the review and data managers. The director functions to analyze the real-time data based upon the profile. The analysis of the director includes a comparison of the real-time data with both the lower and upper values and correlation of an electronic event schedule of the user with the historical data. The director provides one or more recommendation to the user in real-time based upon the analysis, and also updates the profile in real-time.

In yet another aspect of the invention, a computer program product is provided with a computer readable storage medium having embodied computer readable program code. More specifically, computer readable program code is provided to create a user profile and store the profile in memory. The user profile includes historical data associated with one or more vitals of the user. Computer readable program code is provided to analyze the historical data, including determine upper and lower values for the one or more vitals over a predetermined time interval. In addition, computer readable program code is provided to continuously acquire real-time data associated with at least one vital of the user and to analyze the acquired data based upon the profile. The analysis includes comparison of the real-time data with both the upper and lower values and correlation with an electronic event schedule of the user to the historical data. Computer readable program code is then employed to provide recommendation to the user in real-time based upon the analysis, and to update the profile with the real-time data.

Other features and advantages of this invention will become apparent from the following detailed description of the presently preferred embodiment of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart illustrating a process for monitoring and managing the lifestyle of a user.

FIG. 2 is a flow chart illustrating a customizable profile for monitoring health related concerns of a user.

FIG. 3 is a flow chart illustrating a process for leveraging an external program with the self-imposed limits of the user.

FIG. 4 is a block diagram of a computer system with tools to support a sensor management and analysis, according to the preferred embodiment of this invention, and is suggested for printing on the first page of the issued patent.

FIG. 5 is a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers and directors. A functional unit may be implemented in programmable hardware devices such as field programmable gate arrays, programmable array logic, programmable logic devices, or the like. The functional unit may also be implemented in software for processing by various types of processors. A functional unit of executable code may, for instance, comprise one or more physical or logical blocks of computer instructions which may, for instance, be organized as an object, procedure, function, or other construct. Nevertheless, the executables of an identified functional unit need not be physically located together, but may comprise disparate instructions stored in different locations which, when joined logically together, comprise the functional unit and achieve the stated purpose of the manager functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a review manager, a data manager, a director, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A profile of a user performing regularly scheduled tasks is monitored in real-time. As described in the prior art, it is known in the art for individuals to be monitored in a closed setting. More specifically, it is known when a user goes to a doctor's office and sensors are placed on their body, that data is collected and analyzed, or that a user can exercise under the care of a professional. However, people do not live in hospitals and doctors offices. Monitoring of the individual is expanded to an open environment. Data is gathered actively or passively during normal activity and over a period of time without placing sensors on the user's body. This data is gathered in a dynamic manner and analyzed as such, so that the data gathering and analysis reflects the lifestyle of the user.

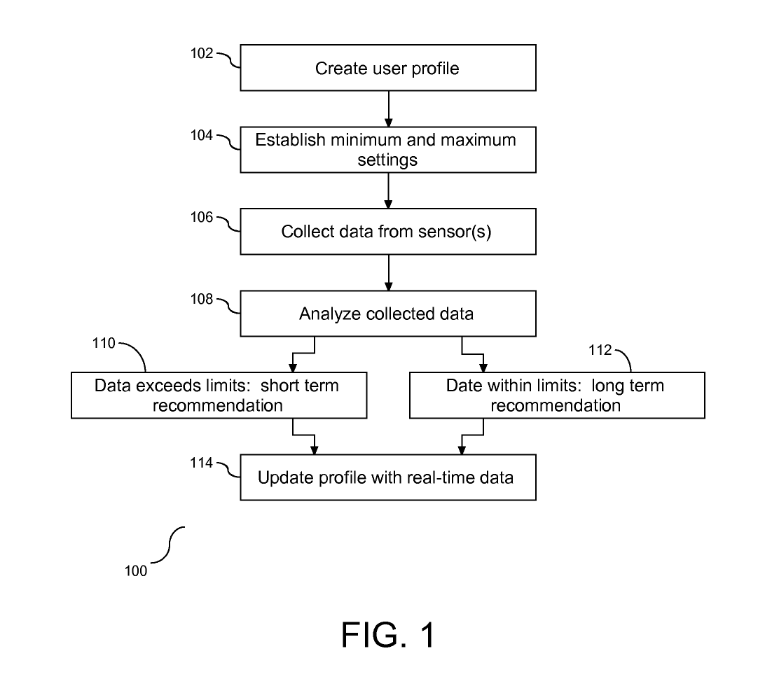

FIG. 1 is a flow chart (100) illustrating a process for monitoring and managing the lifestyle of a user. As shown herein, a user profile is created (102). More specifically, each user established preferences and settings as a baseline for their monitor profile. Additionally, at the time the user profile is created, maximum and minimum limits are established with the data settings (104). The baseline enables the monitoring to reflect the specific individual and the needs of the individual, while the maximum and minimum establishes the limits associated with the specific vital of the user. In one embodiment, the profile contains information associated with at least one vital of the user. Once the profile is created, a baseline is present and available. In one embodiment, as data is collected, a historical profile is created. Accordingly, while the profile initially contains data input by a user, over time the profile is expanded to reflect the historical nature of the user based upon gathered data.

Following establishment of the profile, data may be collected from one or more sensors (106). There are many sensors available on the market that may be employed to gather data about the user. Examples of such sensors include, but are not limited to, activity of a computer mouse, activity of a computer keyboard, movement of a user in front of a web camera, pulse and body temperature monitor, blood pressure monitor, weight scale, etc. The sensors may be passive sensors or active sensors. Regardless of the classification of the sensor, as the data is collected from one or more sensors, it is analyzed with respect to the user profile (108). Accordingly, data is gathered and analyzed on an individual basis including an analysis of the profile data compared to the gathered data.

As noted above, the gathered data is put through an analysis. See step (108). The purpose of the analysis is to determine if there is short term or long term assessment concerns. In one embodiment, the sensors gather data in real-time. As such, the analysis performed at step (108) and the resulting assessment is conducted in real time. In one embodiment, the analysis at step (108) includes both comparison of the real-time data with the upper and lower value and a correlation of the data of an electronic event schedule of the user to historical data. Similarly, in one embodiment, the correlation is an automated action. If it is determined at step (108) that the analyzed data exceeds one of the limits set at step (104) or does not correlation to a scheduled event, a short term recommendation is communicated to the user (110). Conversely, if it is determined at step (108) that the analyzed data is within the limits set at step (104) or correlates to a scheduled event, a long term recommendation is communicated to the user (112). An example of a short term recommendation includes, but is not limited to, an immediate action to mitigate any foreseeable concerns. For example, an immediate action may include changing physical position, getting fluids, seeking immediate medical attention, etc. Similarly, an example of a long term recommendation includes, but is not limited to recommended actions to maintain or improve long term health. In one embodiment, an avatar is provided as an output medium for the recommendation communicated to the user at steps (110) and (112). The avatar provides a visual medium for representation of health related concerns to the user. Following steps (110) and (112), the profile of the user is updated with the real-time data at pre-determined intervals (114). This update of the profile is employed to ensure that the user profile accurately portrays the user. For example, if the profile includes the weight of the user, the profile may be updated when the weight has changed. The update of the profile may be conducted on a real-time or non-real-time basis. Accordingly, both long term and short term recommendations are provided to the user in real-time based upon data gathered from one or more sensors.

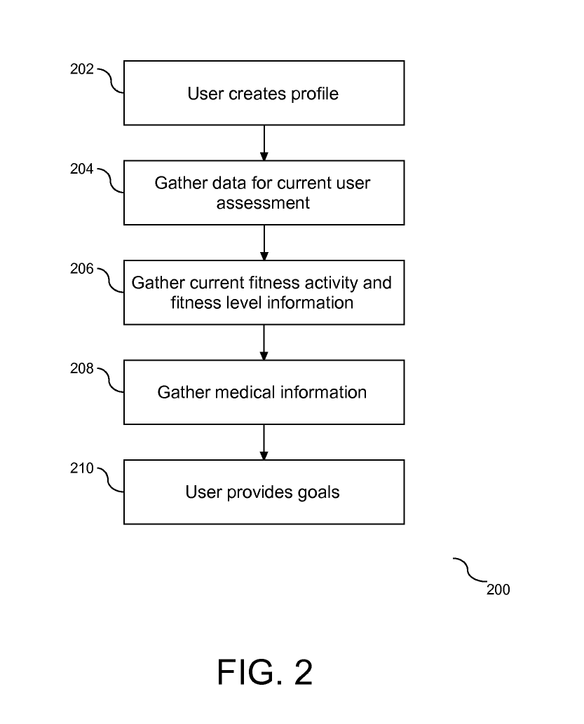

The analysis demonstrated in FIG. 1 is based upon defined limits. FIG. 2 is a flow chart (200) illustrating a customizable profile for monitoring health related concerns of a user. More specifically, the user may design a profile based upon their current state of being, desired goals, preferences, etc. As such, the user creates a profile outlining their specific characteristics (202). With the user of one or more sensors, data is gathered for a current assessment of the user (204). For example, the data may include, but is not limited to, resting blood pressure, heart rate, weight, fitness level, etc. At the same time, information pertaining to the current fitness activity and fitness level of the user is gathered (206). The user may be physically fit, or not. Regardless of the current set of activity, it is important to ascertain the current state of the user. In addition, it is important to gather information pertaining to any medical issues of the user (208). For example, if the user is diabetic, allergies, etc. All of these can be issues that may need to be addressed in order to maintain a healthy lifestyle and/or work environment. After the user has completed creation of their profile data, the user also provides their desired goals (210). More specifically, the user identifies elements that they want monitored and communicated to them. In one embodiment, the user establishes their maximum and minimum limits for assessment and communication, as demonstrated in FIG. 1. Accordingly, the user may establish their own profile for monitoring specific goals.

An avatar is one form of communication with the user. In one embodiment, the avatar may be configured to resemble the physique of the user. As data is gathered pertaining to a physical part of the body that requires attention, the avatar may be morphed to highlight this area in a visual manner. Similarly, based upon data gathered and established settings, the avatar may suggest different physical activities for the user. Examples of immediate physical activities include, but are not limited to, stretching, liquid intake, eating, changing posture, taking a walk, physical exercise, seeking medical attention. Not all of the assessments from the gathered data require immediate attention. In one embodiment, long term recommendations may be communicated to the user via the avatar or a different communication medium. Examples of long term recommendations may include nutrition, hydration, weight, environment, etc. The avatar is one visual output form that may be employed. Other forms of communication to the user may be employed.

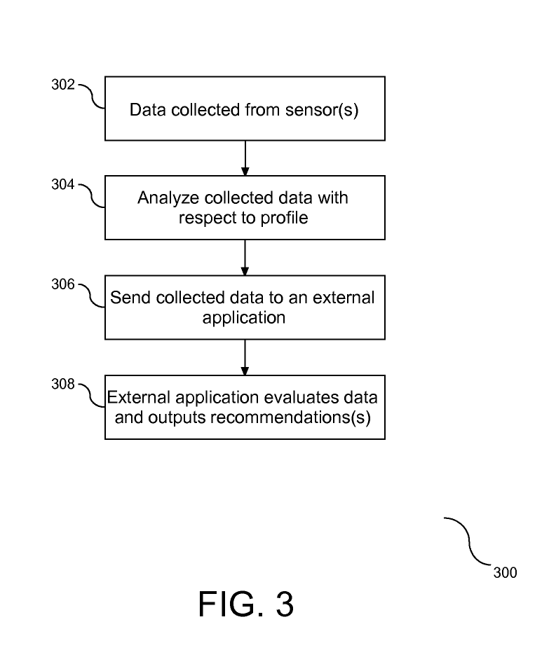

As demonstrated above, the user may input limits associated with gathered and evaluated data. Similarly, different output mediums may be employed to communicate with the user. However, there may be an external application that may be employed in the evaluation of data. For example, the user may want to employ a wellness program to maintain a healthy lifestyle and leverage the advantages of the program with the self-imposed limits. FIG. 3 is a flow chart (300) illustrating a process for leveraging an external program with the self-imposed limits of the user. As illustrated in FIG. 1, data may be collected from one or more sensors (302). There are many sensors available on the market that may be employed to gather data about the user. Examples of such sensors include, but are not limited to, activity of a computer mouse, activity of a computer keyboard, movement of a user in front of a web camera, pulse and body temperature monitor, blood pressure monitor, weight scale, etc. The sensors may be passive sensors or active sensors. Regardless of the classification of the sensor, as the data is collected from the one or more sensors, it is analyzed with respect to the user profile (304). At the same time, the collected data is sent to an external application for evaluation (306). Although the external application cannot provide analysis of the data in real-time, the external application may be employed to provide evaluation and counseling for long term goals. Examples of external applications include, but are not limited to, weight management, wellness program(s), nutrition programs, fitness monitoring program, etc. The external applications evaluate the collected data as input and provide one or more recommendations as output (308). Accordingly, data is gathered and exchanged with an external application to provide long term counseling to the user based upon collected data.

It is known that when a person visits with a doctor, the visit addresses current problems and concerns. The historical data provided to the doctor is from a prior visit or test. The use of sensors in an everyday environment supports gathering of user data in a real-life situation. As demonstrated in FIGS. 1 and 2, data output may be communicated to the user in real-time. In one embodiment, a message may “pop-up” on a local visual display to communicate recommendations for the user in real-time based upon current data gathering and evaluation. Real-time recommendations may pertain to immediate actions and the quantity or length of such immediate actions, including, but not limited to drinking fluids, eating, changing positions, stretching, seeking immediate medical attention, etc. For example, in one embodiment, a real-time recommendation may be for the user to take a break from their work, and ensure this is done by placing their work computer into a hibernate mode for a set period of time or until sensor data is received and evaluated. Conversely, as demonstrated in FIG. 3, the gathered data may be employed to evaluate the user from a long term prospective and to help ascertain long term goals for a healthy or healthier lifestyle. Examples of long-term recommendations communicated to the user may include, but are not limited to, nutrition advice, hydration advice, weight management, environmental evaluation, and vital statistics. Accordingly, the data gathered by the sensors is evaluated in real-time as input, with output communicated to the user in real-time and/or non-real-time, depending upon the applications selected for evaluation of the sensor data.

In each of the embodiments illustrated in FIGS. 1-3, data is gathered on a periodic basis in a real world environment. Most people follow a schedule. For example, there are work hours and non-work hours. The data gathered from the sensors is stored to maintain a history of the user and their actions. This enables an application to ascertain a daily, weekly, and or monthly schedule of the user. Evaluations of current data based upon historical data may then be conducted based upon the hour, day, month, etc. In addition, it is known that the user may organize regularly or non-regularly scheduled events on an electronic event schedule, such as an electronic calendar. Evaluation of the current data may correlate the electronic event schedule and account for scheduled events.

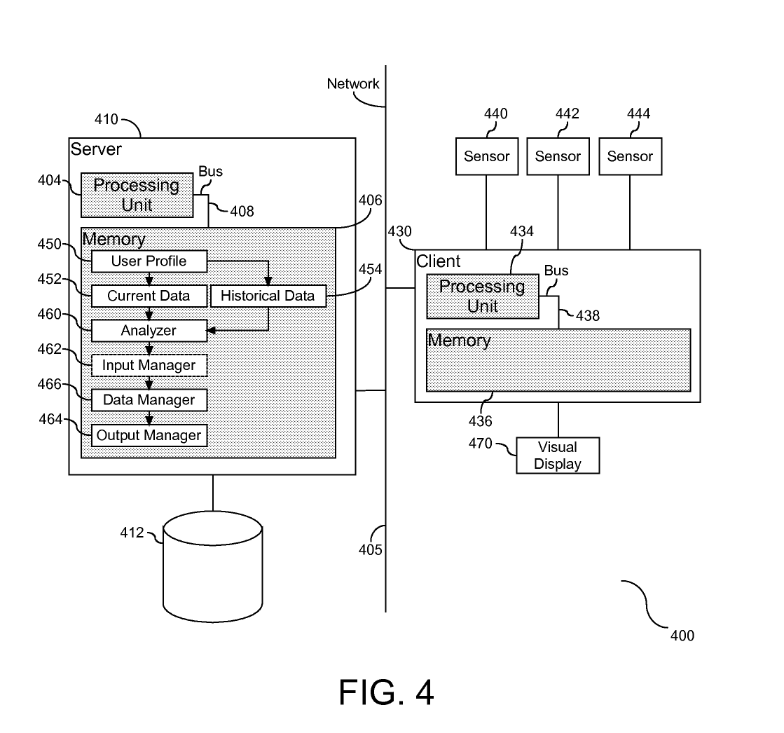

As demonstrated in the flow charts of FIGS. 1-3, a method is employed to both monitor and manage characteristics of a user in a real world environment. FIG. 4 is a block diagram (400) illustrating tools embedded in a computer system to support the aspects of monitoring and management of the user based upon gathered real world data and the evaluation thereof. A computer system is shown with a server (410) in communication with one or more client machines (430) across a network (405). Although only one server and one client machine are shown in the example herein, the invention should not be limited to this quantity of machines in the system.

The server (410) is provided with a processing unit (404), in communication with memory (406) across a bus (408) and in communication with data storage (412). The client machine is provided with a processing unit (434), in communication with memory (436) across a bus (438), and is in communication with the server (410) across the network (405). External sensors (440), (442), and (444) are shown in communication with the client machines. In addition, the client (430) is provided with a visual display (470) to convey and present visual data. Although only three sensors are shown, the invention should not be limited to the quantity of sensors shown herein. Each of the sensors (440), (442), and (444) are employed to gather data pertaining to the user and the user's environment. Examples of sensor data gathered include, but are not limited to, personal monitoring sensors, such as glucose, body mass, activity, weight, body temperature, heart rate, blood pressure, and environmental sensors to gather data related to the location, such as temperature, humidity, etc. Data gathered by the sensors (440), (442), and (444) is received as input to the client machine (430) and communicated to the server (410).

As illustrated in FIG. 1, prior to gathering data, a user profile is created and thereafter maintained. More specifically, the user profile (450) is input through the client machine (430) and communicated to the server (410), where it is stored. The user profile (450) includes both current data (452) as the data is gathered, and historical data (454) after the data is processed. In addition, the user profile contains boundaries pertaining to upper and lower limits to define the data as it is processed. As shown herein, server node (410) is provided with an analyzer (460) to analyze both historical data and current data in real-time. More specifically, the analyzer (460) reviews acquired data against the limits as defined by the user. In one embodiment, the analyzer uses the historical data to ascertain and/or project a user's schedule. For example, the user may have a certain schedule during work hours, and the historical data should reflect the frequency by which sensor data repeats during work hours. In one embodiment, the user maintains an electronic event schedule (472), such as an electronic calendar. The analyzer (460) may consult the schedule (472) to coordinate the analysis of the gathered data with any schedule events present on the schedule, including periodic and non-periodic events. For example, the user may have a schedule of periodic or non-periodic events in their schedule (472). A change in the gathered sensor data may reflect an event in the schedule (472). In the case of a periodic event, the analyzer (460) may evaluate the data to assess similarities in the gathered data with respect to the periodic event. Similarly, if a periodic event is subject to a change, such as a different time of the data, the analyzer (460) may evaluate the current data with respect to the change in the schedule event. Accordingly, the analyzer (460) processes current data and correlates it with past data, the boundaries as defined in the profile, and an electronic event schedule to assess the state of the user.

An input manager (462) is shown in communication with the analyzer (460). The input manager (462) functions to acquire real-time data in a continuous manner as received from the sensors (440), (442), and (444) in communication with the client machine. As data is received, processed, and tracked in an ongoing manner, a data manager (466) is provided to update the user profile (450). In one embodiment, the profile update takes place at periodic intervals. Similarly, in one embodiment, the profile update takes place in real-time. Based upon the analysis of the acquired data as performed by the analyzer (460), output may be communicated to the user in real-time or non-real-time. An output manager (464) is provided in communication with the analyzer and provides real-time recommendations to the user based upon the analysis of the analyzer (460). More specifically, the output manager (464) notifies the user when the real-time data falls outside of the boundary range as defined in the profile. The notification can take place in different forms, including use of a third party application, an employer application, etc. In one embodiment, the notification may be communicated to the user, colleagues, a manager, family member, emergency services, etc. The notification communicates the analyzed data in an intelligible manner. For data that pertains to health and maintaining a healthy lifestyle, the notification enables the user to manage their health on a granular level as opposed to measurements taken on a less frequent basis, such as when visiting a doctor's office. Accordingly, the notification supports the real-time analysis and communication of output to the user.

As identified above, the analyzer (460), input manager (462), output manager (464), and data manager (466) function to manage gathering and analysis of sensor data, and communication of the analyzed data in real-time. The analyzer (460) and managers (462), (464), and (466) are shown residing in memory local to the server (410). More specifically, analyzer (460), input manager (462), output manager (464) and data manager (466) each reside in memory (406) of server (410). Although in one embodiment, the analyzer (460) and managers (462), (466), and (464) may reside as hardware tools external to memory of the server (410), or they may be implemented as a combination of hardware and software. Similarly, in one embodiment, the analyzer (460) and managers (462), (464), and (466) may be combined into a single functional item that incorporates the functionality of the separate items. As shown herein, each of the analyzer (460) and manager(s) (462), (464), and (466) are shown local to server (410). However, in one embodiment they may be collectively or individually distributed across the network and function as a unit to manage collection, analysis, and communication of data in real-time. Accordingly, the analyzer and managers may be implemented as software tools, hardware tools, or a combination of software and hardware tools, to collect and organize data content.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

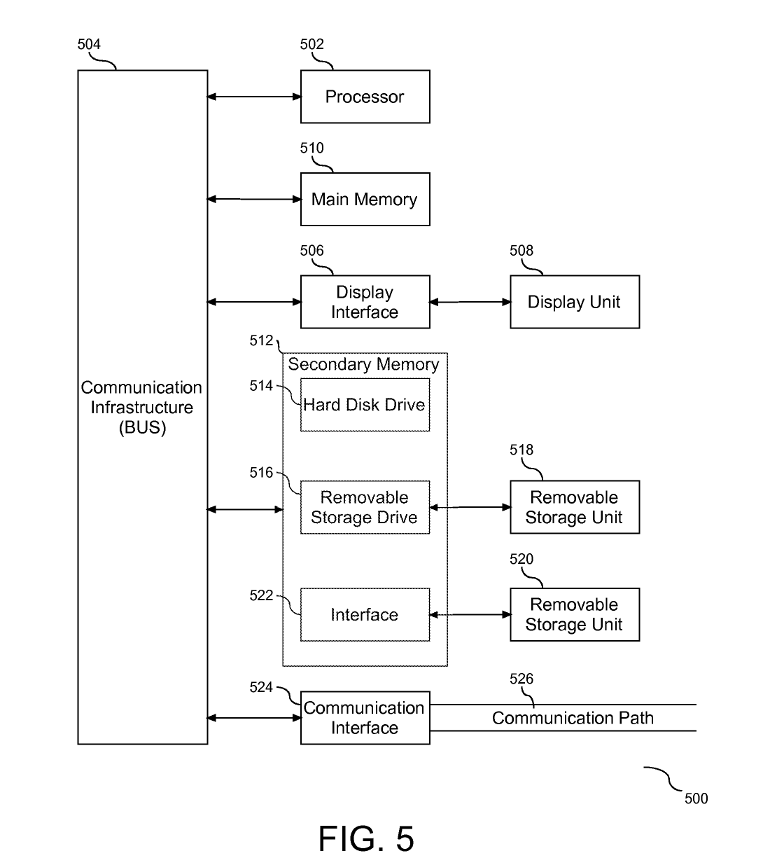

Referring now to FIG. 5, a block diagram (500) is showing a computer system for implementing an embodiment of the present invention. The computer system includes one or more processors, such as a processor (502). The processor (502) is connected to a communication infrastructure (504) (e.g., a communications bus, cross-over bar, or network).

The computer system can include a display interface (506) that forwards graphics, text, and other data from the communication infrastructure (504) (or from a frame buffer not shown) for display on a display unit (508). The computer system also includes a main memory (510), preferably random access memory (RAM), and may also include a secondary memory (512). The secondary memory (512) may include, for example, a hard disk drive (514) and/or a removable storage drive (516), representing, for example, a floppy disk drive, a magnetic tape drive, or an optical disk drive. The removable storage drive (516) reads from and/or writes to a removable storage unit (518) in a manner well known to those having ordinary skill in the art. Removable storage unit (518) represents, for example, a floppy disk, a compact disc, a magnetic tape, or an optical disk, etc., which is read by and written to by removable storage drive (516). As will be appreciated, the removable storage unit (518) includes a computer readable medium having stored therein computer software and/or data.

In alternative embodiments, the secondary memory (512) may include other similar means for allowing computer programs or other instructions to be loaded into the computer system. Such means may include, for example, a removable storage unit (520) and an interface (522). Examples of such means may include a program package and package interface (such as that found in video game devices), a removable memory chip (such as an EPROM, or PROM) and associated socket, and other removable storage units (520) and interfaces (522) which allow software and data to be transferred from the removable storage unit (520) to the computer system.

The computer system may also include a communications interface (524). The communications interface (524) allows software and data to be transferred between the computer system and external devices. Examples of communications interface (524) may include a modem, a network interface (such as an Ethernet card), a communications port, or a PCMCIA slot and card, etc. Software and data transferred via communications interface (524) are in the form of signals which may be, for example, electronic, electromagnetic, optical, or other signals capable of being received by communications interface (524). These signals are provided to communications interface (524) via a communications path (i.e., channel) (526). This communications path (526) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (510) and secondary memory (512), removable storage drive (516), and a hard disk installed in hard disk drive (514).

Computer programs (also called computer control logic) are stored in main memory (510) and/or secondary memory (512). Computer programs may also be received via a communication interface (524). Such computer programs, when run, enable the computer system to perform the features of the present invention as discussed herein. In particular, the computer programs, when run, enable the processor (502) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method comprising:
providing a processor in communication with memory;
creating a user profile stored in said memory, said profile including historical data associated with at least one vital of said user;
analyzing said historical data, including determining lower and upper values for at least one of said vitals over a predetermined time interval;
continuously acquiring real-time data associated with said at least one vital of said user;
analyzing said real-time data based upon said profile, including comparing said real-time data with said lower and upper values and correlating an electronic event schedule of said user to said historical data;
in real-time providing recommendations to said user based upon said analysis;
updating said profile with said real-time data.

2. The method of claim 1, further comprising acquiring said real-time data from a sensor in communication with said user, said sensor selected from the group consisting of: an environmental sensor, a personal monitoring sensor, and a combination thereof.

3. The method of claim 2, wherein said sensor is incorporated into a computer system employed by said user.

4. The method of claim 1, further comprising said profile including settings defining a preferable range for each of said acquired data and notifying said user when said real-time data falls outside of said preferable range.

5. The method of claim 1, further comprising notifying said user when said real-time data falls outside an interval defined by said upper value and lower value determined based upon said historical data.

6. The method of claim 1, further comprising supporting data exchange between said profile and an external application, said external application is selected from the grouping consisting of: a third party application, an employer application, and a combination thereof.

7. The method of claim 1, wherein said recommendations include real-time recommendations and long term recommendations.

8. The method of claim 1, wherein the step of correlating a schedule of said user to historical data includes consulting a schedule of said user as documented in a calendar, and performing said correlation in an automated manner.

9. A system comprising:
a processor in communication with memory;
a user profile stored in said memory, said profile including historical data associated with at least one vital of said user;
a review manager to analyze said historical data including determining lower and upper values for at least one of said vitals over a predetermined time interval;
a data manager to continuously acquire real-time data associated with said at least one vital of said user;
a director in communication with said review manager and said data manager, said director to analyze said real-time data based upon said profile, including comparing said real-time data with said lower and upper values and correlating an electronic event schedule of said user to said historical data;
said director to provide recommendations to said user in real-time based upon said analysis; and
said director to update said profile with said real-time data.

10. The system of claim 9, further comprising a sensor in communication with said user, said director to acquire from the sensor real-time data selected from the group consisting of: an environmental sensor, a personal monitoring sensor, and a combination thereof.

11. The system of claim 10, wherein said sensor is incorporated into a computer system employed by said user.

12. The system of claim 10, further comprising said profile including settings defining a preferable range for each of said acquired data and notifying said user when said real-time data falls outside of said preferable range.

13. The system of claim 9, further comprising said director to notify said user when said real-time data falls outside an interval defined by said upper value and lower value determined based upon said historical data.

14. The system of claim 9, further comprising supporting data exchange between said profile and an external application, said external application is selected from the grouping consisting of: a third party application, an employer application, and a combination thereof.

15. The system of claim 9, wherein said recommendations include real-time recommendations and long term recommendations.

16. The system of claim 9, wherein the schedule correlation by the director includes consulting a schedule of said user as documented in a calendar, and performance of said correlation in an automated manner.

17. A computer program product, the computer program product comprising a computer readable storage medium having computer readable program code embodied therewith, the computer readable program code comprising:
computer readable program code configured to create a user profile stored in memory, said profile including historical data associated with at least one vital of said user;
computer readable program code configured to analyze said historical data including determining lower and upper values for at least one of said vitals over a predetermined time interval;
computer readable program code configured to continuously acquire real-time data associated with said at least one vital of said user;
computer readable program code configured to analyze said real-time data based upon said profile, including comparing said real-time data with said lower and upper values and automatically correlating an electronic event schedule of said user to said historical data;
computer readable program code configured to in real-time provide recommendations to said user based upon said analysis; and
computer readable program code configured to update said profile with said real-time data.

18. The computer program product of claim 17, further comprising computer readable program code to acquire said real-time data from a sensor in communication with said user, said sensor selected from the group consisting of: an environmental sensor, a personal monitoring sensor, and a combination thereof.

19. The computer program product of claim 17, further comprising said profile including settings defining a preferable range for each of said acquired data and computer readable program code to notify said user when said real-time data falls outside of said preferable range.

20. The computer program product of claim 17, further comprising computer readable program code to notify said user when said real-time data falls outside an interval defined by said upper value and lower value determined based upon said historical data.
